(19) United States
(12) Patent Application Publication
(10) Pub. No.: US 2007/0074774 A1
(43) Pub. Date: Apr. 5, 2007

(54) Lining of pipelines and passageways

(75) Inventor: Brian Chandler, Bedford (GB)

Correspondence Address: BARLOW, JOSEPHS & HOLMES, LTD., 101 DYER STREET, 5TH FLOOR, PROVIDENCE, RI, 02903, US

(73) Assignee: The Pipeline Centre, Farrington Road, Burnley (GB)

(21) Appl. No.: 10/595,171

(22) PCT Filed: Sep. 15, 2004
(86) PCT No.: PCT/GB04/03944

§ 371 Date: Nov. 27, 2006

(30) Foreign Application Priority Data
Sep. 16, 2003 (GB) 0321636.3

(51) Int. Cl. F16L 55/16

(52) U.S. Cl. 138/98

(57) ABSTRACT

The invention relates to the formation of a tube (34) and the provision of the tube (34) to line a host pipe and hence repair and/or strengthen the same. The tube is formed of a web (10) of material to which at least one wire strip (18) is applied such that when the web (10) of material is introduced into the host pipe, the at least one wire strip is located at the overlapping longitudinal edges of the web (10). The tube (34) is expanded to the internal size of the host pipe and electric current applied to the wires in the wire strip (18) to heat the same and bond the overlapping edges together.

This invention relates to the lining of pipelines and passageways using lining tubes and also to a new method of relining leaking and corroding pipes, such as water or gas pipes.

In the majority of cases, the lining process will be applied to the lining of pipelines, specifically pipelines carrying service fluids such as gas, water, oil and chemicals, preferably after cleaning of pipes which carry oil and chemicals, but the method can be applied to short lengths of pipeline, which may be more accurately described as pipes. Also, the invention can be applied to what are more accurately described as passageways, and one is thinking in particular of underground passageways which are formed for example of brick or concrete segments, such as are used for sewers. In all cases however, the lining tube is placed on a surface, which is an inner surface acting as a host for the lining tube, and so all of the pipelines, pipes and passageways will be referred to hereinafter in the interests of simplicity as “host pipes”.

The invention is concerned mainly with the lining of host pipes for carrying water and gas, although the invention is not limited to such applications. In gas and water pipe lining operations, it is important that the lining tube should be a tight fit on the host pipe surface, to prevent leakage of the water or gas. In water host pipes made of iron, if the lining tube does not fit tightly, then air and water can collect in pockets behind the lining tube leading to corrosion problems. Also, leakage of water results in expensive waste. It is estimated that 30% of water supplied from the mains leaks and does not reach the consumption taps. Leakage of gas is dangerous as well as expensive.

There ate already known or have been proposed many systems for the lining of gas and water host pipes, and without exception, these have difficulties.

In one proposed system, a lining pipe of medium density polyethylene is subjected to a squeezing and stretching operation to reduce it from a nominal diameter related to the diameter of the host pipe, and the reduced diameter lining tube is pulled into the host pipe whilst the stretching force is maintained. When the tube is in the host pipe, the stretching tension is released, and the tube returns to the nominal diameter. At least that is what is intended but frequently this is not achieved and the disadvantages mentioned above result. Also, if there are any protrusions in the host pipe (such as are caused by service connections known as “laterals”) these physically prevent the tube from returning to the nominal diameter at the protrusions. As such, there is a risk that an annulus is left along a length of the pipe where gas can become trapped or water can collect, become stagnant and cause contamination.

This method also experiences difficulty if the host pipe is of varying diameter such as occurs in old cast iron host pipes.

In another system, a lining tube is pre-extruded, such as for example by bending a lining tube of plastics material into a U section (to reduce its overall diameter) so that it can be inserted into the host pipe, and when in the host pipe it is expanded (for example using steam under pressure) back to circular form, tightly fitting the host pipe. Again however in practice this tight fitting, especially over the whole length of the host pipe, rarely takes place and the problems with air pockets or annulus formation behind the installed lining tube arise.

The processes in which plastics pipes are deformed and then returned to the original size generally do not work because plastic has a “memory” and will tend to return towards the deformed state, with the passage of time.

Tight fitting of a lining tube in a host pipe can be achieved using a web of plastics material which can be heat sealed, by coiling the web until the longitudinal edges overlap to a first predetermined degree, defining a lining tube of a diameter which is a fraction, say 60%, of the diameter of the host pipe. The tube is placed in the host pipe in this condition. It is held in this condition by releasable holding means such as spaced, breakable adhesive straps extending around the tube and over the overlapping edges. When the tube is in the host pipe, the straps are broken and the tube can then uncoil, being assisted by pressurizing the tube interior. The tube uncoils until the said longitudinal edges overlap by a second predetermined amount less than the first predetermined amount, and the tube now lies tightly against the host pipe wall. The overlapping edges are then heat sealed together, by any suitable means, such as by heating resistance wires placed between the overlapped edges.

This method overcomes the problems of the known systems indicated above, but it has its own problem which is that there is a tendency for foreign matter, dirt and dust and the like to infiltrate between the overlapping surfaces of the tube overlap, and this matter can lead to inefficient heat sealing. As can be appreciated from the above, if the sealing of the overlapped edges is inefficient, then the leakage problems will still occur, albeit in a different way.

The present invention seeks in its various aspects, to provide a lining tube which can be used for the effective lining of host pipes to obviate or mitigate the above disadvantages. The invention also provides a method of lining host pipes with lining tubes resulting in tightly fitting and effectively sealed arrangements. By virtue of the invention, the lining tubes can be manufactured under factory controlled conditions, and all materials can be kept clean, and by virtue of the invention, even if the lining tube has to be made up on site, by virtue of its construction, the surfaces to be welded can still be kept clean for effective heat sealing of the lining tube when in the host pipe.

According to the present invention in one aspect, there is provided a tube made by introducing an elongated web of heat sealable plastics material through a former and into a host pipe with the longitudinal edges of the web overlapping by a first predetermined amount, the host pipe of diameter larger than that of the tube, said tube expanded up to the diameter of the host pipe until the overlapping edges overlap by a second predetermined amount less than the first predetermined amount, after which the overlapped edges are heat sealed together, wherein the heat sealing is effected by the introduction of electric current along at least one wire strip positioned between the overlapping edges, said wire strip heating to a sufficient extent to form a bond between the material of the overlapping edges.

Thus there is provided a tube made by coiling an elongated web of heat sealable plastics material until the longitudinal edges of the web overlap by a first predetermined amount, the tube being for insertion into a host pipe of diameter larger than that of the tube and expansion up to the diameter of the host pipe until the overlapping edges overlap by a second predetermined amount less than the first predetermined amount, after which the overlapped edges can be heat sealed together, and including a sealing means arranged in relation to the overlapped edges to prevent ingress of foreign matter between the edges and into the tube interior, said sealing means being adapted to be released, deformed, expanded, contracted, folded or unfolded so as to allow the tube, after being placed in the host pipe of diameter larger than that of the tube, to be expanded up to the diameter of the host pipe.

The sealing means can be applied under factory conditions so that the completed tube can be taken to site and there will be no possibility of foreign matter reaching the surfaces to be heat sealed together, but in the case of large tubes, the sealing means may be applied or completed on site.

Also according to the invention there is provided a method of lining a host pipe, comprising the steps of introducing an elongated web of plastics material into the host pipe such that longitudinal edges of the web overlap by a first predetermined amount, said host pipe having a diameter larger than that of the tube and the tube is expanded up to the diameter of the host pipe until the overlapping edges overlap by a second predetermined amount less than the first predetermined amount, after which the overlapped edges are sealed together via the heating of wires by providing a current along the same, said wires provided as part of one or more wire strips positioned on the web of plastics material to lie in the overlapping edges of the said web to form a seal between said web material.

The sealing together may by heat applied to perform the sealing, which may be effected by electric resistance wire means provided in one or both of the overlapped edges, such wire means being caused to carry an electric current when the tube is in position.

Other heating means such as a hot iron, laser, infra red heater or the like may be used.

According to another aspect of the invention, the lining tube uses said electric resistance wires between the overlapped edges in a particularly inventive way to overcome problems of supplying too much power to cause the wires to heat up to provide sufficient heat to seal the overlapped edges.

In this aspect of the invention, the electric resistance wires comprise a bank of the wires spaced from each other, and the respective wires, during sealing, are powered sequentially, to limit instantaneous power demand. Thus in this aspect of the invention, which can be independent of the first aspect or more preferably used in conjunction with it, there is provided a lining sheet capable of being formed into a lining tube, with the said bank of wires in place thereon to lie between the overlapped edges when the sheet is coiled to tube form, and a method wherein the overlapped edges are sealed together when the so formed lining tube is in the host pipe and lines the surface thereof, by sequentially powering the wires in the bank of wires. The said sequential powering may be by powering the wires in ones or twos, but not all at once.

Thus, in one aspect, the present invention provides that a channelled, tubular and/or cylindrical member can be formed from a flat, planar sheet, the member once formed trying to return to its original flat state, thereby creating a tight fitting lining for conventional pipework.

Embodiments of the invention in its various aspects will now be described, by way of example, with reference to the accompanying diagrammatic drawings, wherein;

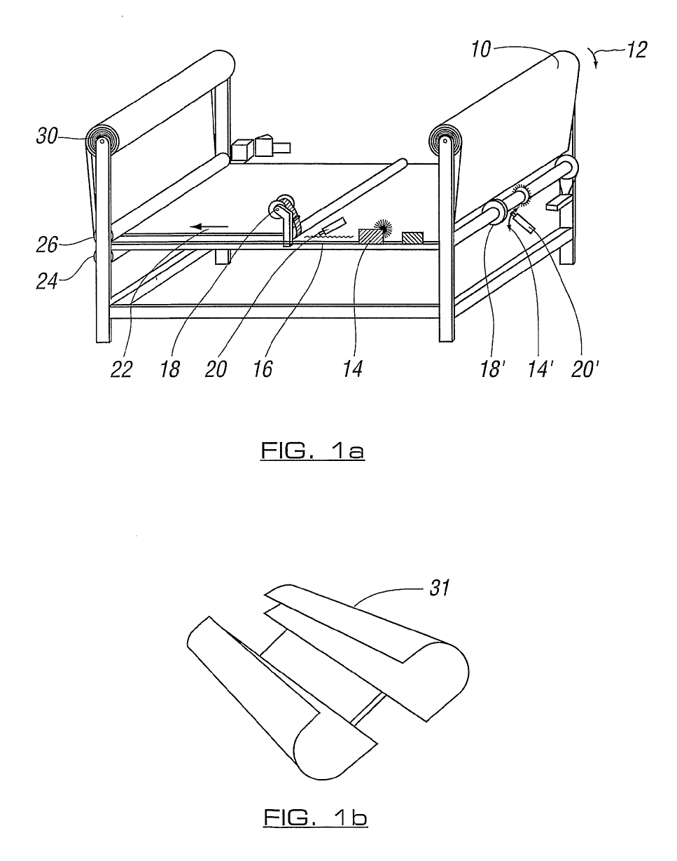

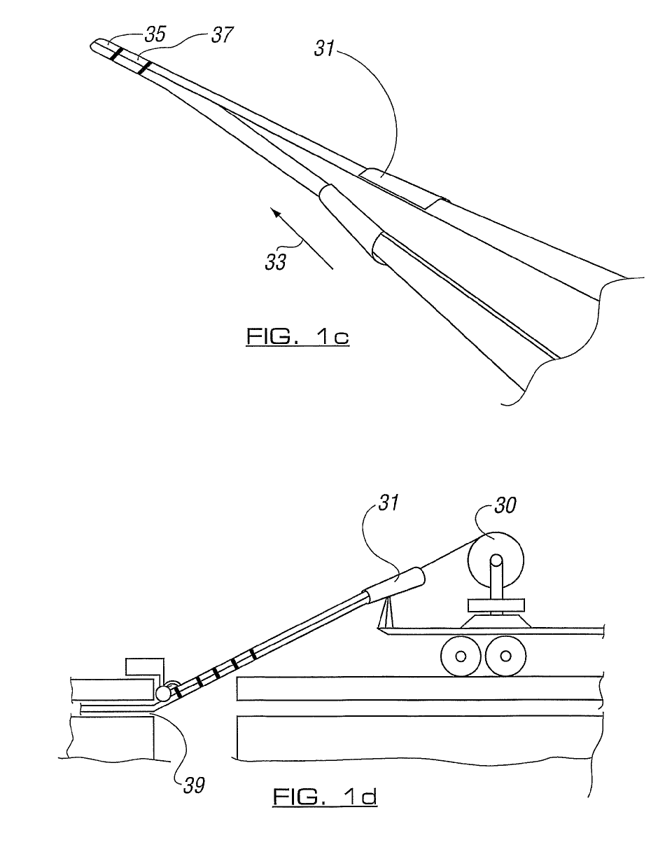

FIG. 1a-d illustrate apparatus used in one embodiment of the invention;

FIG. 2 shows in sections a to d, how the web forming the lining tube of FIG. 1 is treated before coiling;

FIG. 3 is a sectional view of the lining tube at the diameter it takes up when in the host pipe;

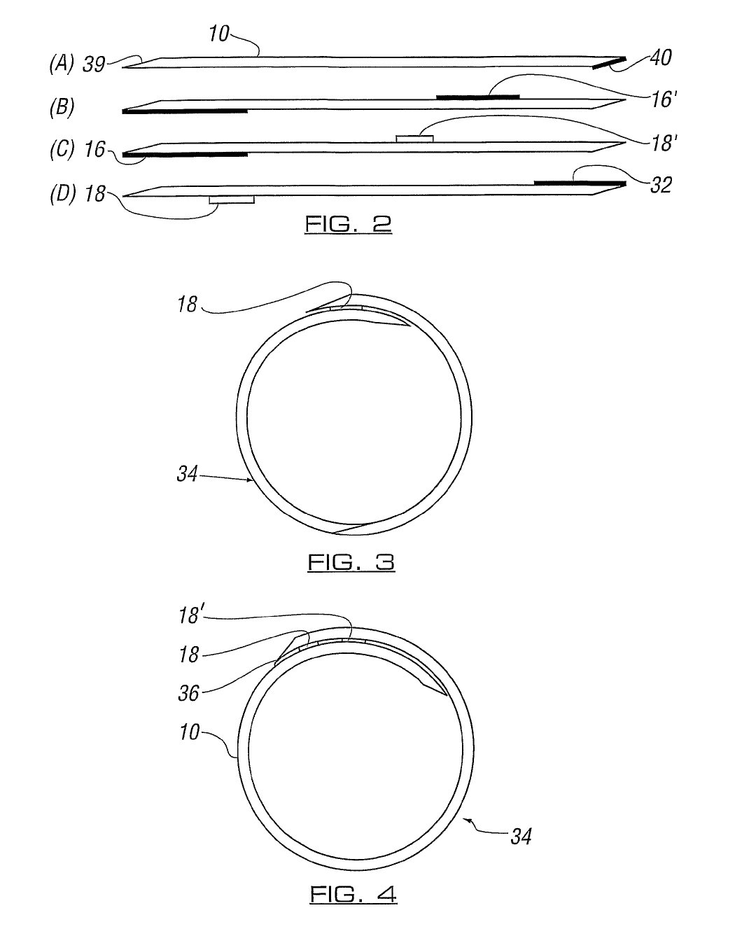

FIG. 4 is a sectional view of the lining tube at the diameter it takes up when it is inserted in the host pipe;

FIG. 5 is a perspective view of a lining tube according to another embodiment of the invention, at the diameter it takes up before it is inserted in the host pipe;

FIG. 6 is a sectional view of the tube of FIG. 5; and

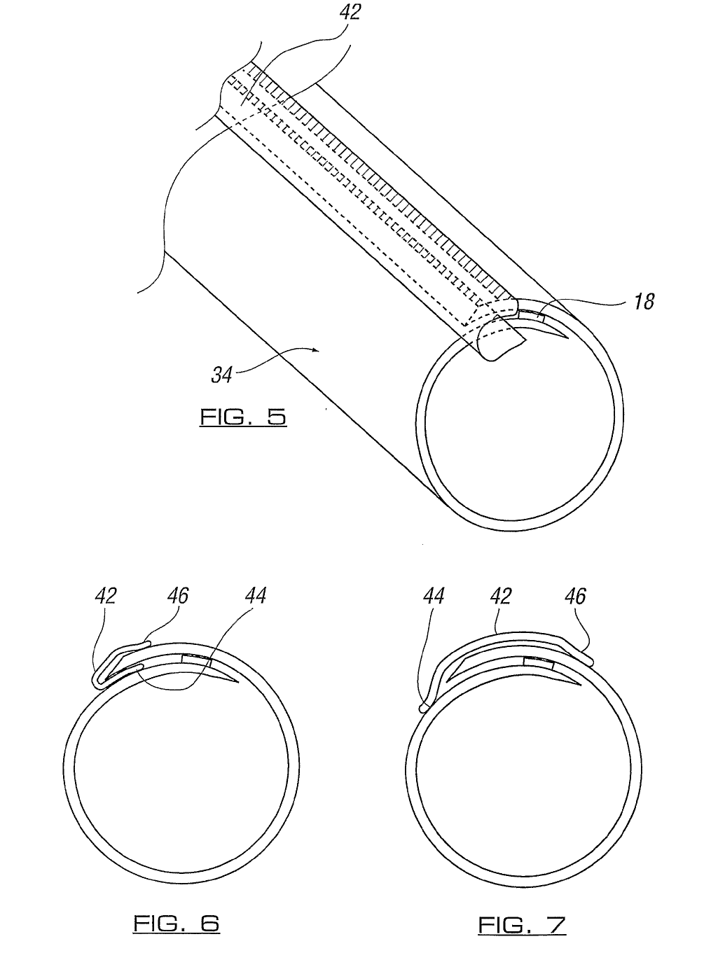

FIG. 7 is a sectional view of the tube of FIG. 5, but in the diameter it takes up when it lines the host pipe;

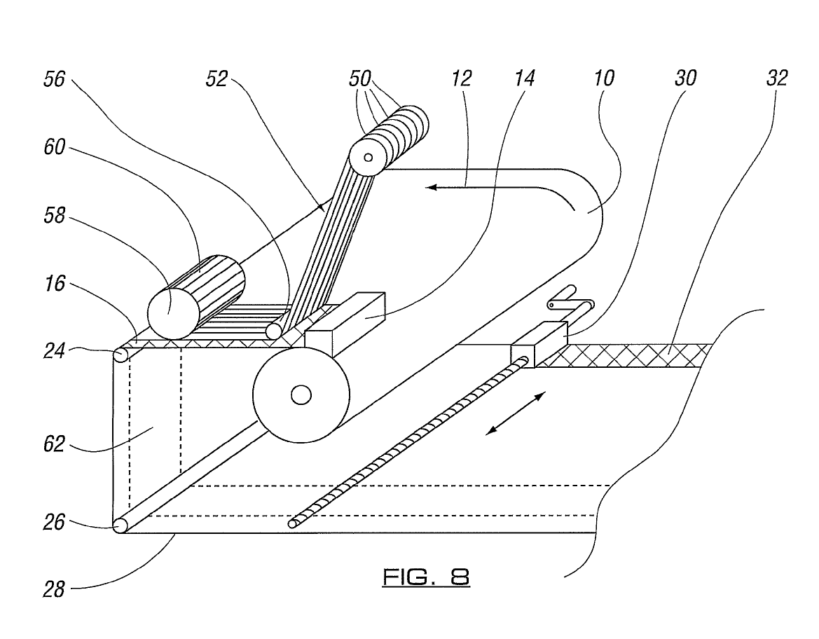

FIG. 8 is view similar to FIG. 1 showing the making of a tube according to another embodiment of the invention;

FIGS. 9 and 10 are a side view and plan view of the arrangement of FIG. 8;

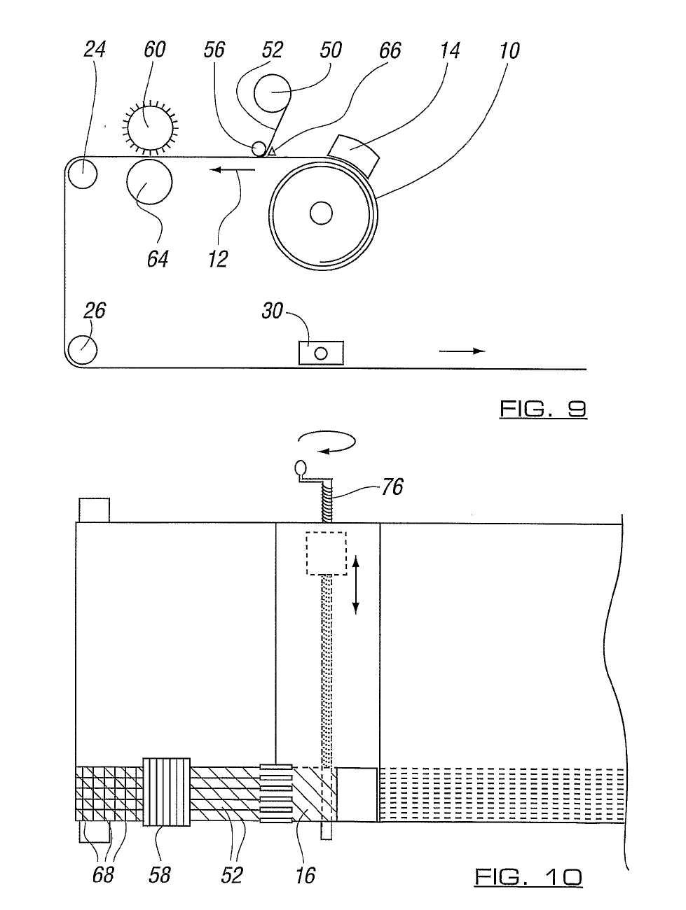

FIG. 11 is a sectional view of the web of FIG. 8;

FIG. 12 is a view similar to FIG. 11 showing the web after further processing;

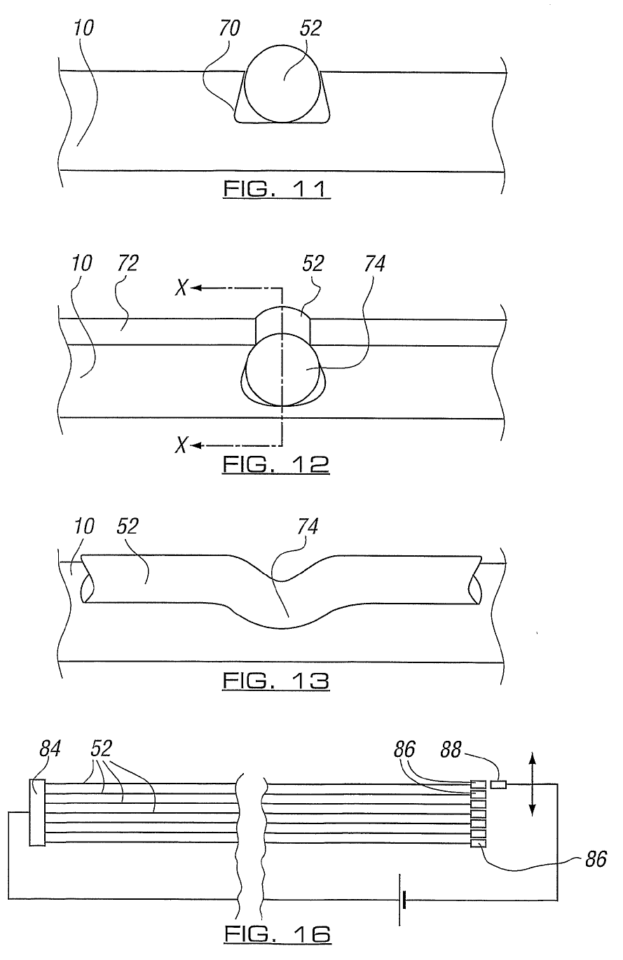

FIG. 13 is a sectional view of the web of FIG. 12 on the line X-X;

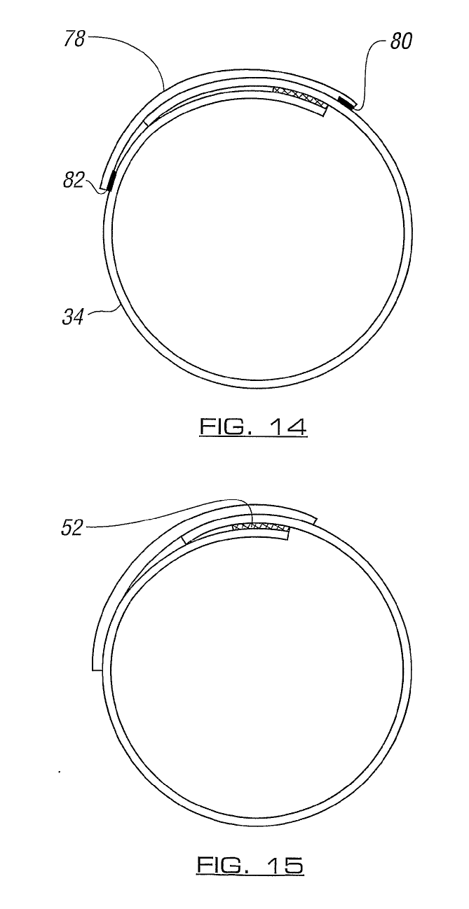

FIG. 14 is a sectional view of the tube made from the web of FIG. 8 before insertion into the host pipe;

FIG. 15 is the same view as FIG. 14, but after the tube has been placed in the host pipe and expanded;

FIG. 16 is a view showing how the electric current is passed through the heating wires of the tube of FIG. 15;

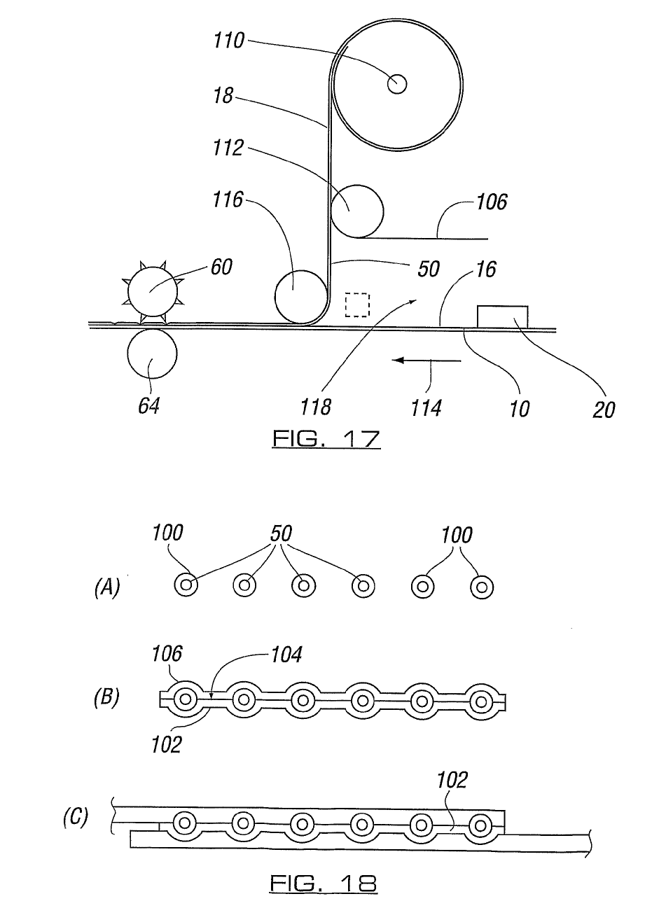

FIG. 17 is a view similar to FIG. 9 but showing a modified arrangement;

FIG. 18 shows in sections A, B and C, how the heating wires shown in FIG. 8 are preferably coated, applied to a carrier tape and are used during powering of same.

Referring to the drawings, and firstly to FIGS. 1a-d apparatus for use in the installation of the lining tube is shown. A roll of the stock material web 10 is illustrated, and the web is unrolled in the direction of arrow 12. This roll can be any length, for example a 200 m long roll can be used. This roll is typically passed through a table or suitable apparatus in an unrolled state for treatment prior to being rerolled for delivery to a pipeline site requiring repair.

The roll can for example be formed from HDPE (high density polyethylene) of about 2 mm thickness. The width of the web used can be approximately 25% wider than the necessary width required to line the host pipe as is discussed in more detail below.

More specifically, at one edge, as the web 10 is being unrolled it is appropriately abraded or chamfered by means of abrasion device 14 which produces an abraded region 16, such as for example the opposite edges of the web and the surface and a portion of the surface adjacent to the edge. This abrasion as will be explained is to enhance the subsequent bonding of the overlapped edges of the web when the tube is finally sealed.

Reference numeral 18 illustrates a roll of tape with wires which when electrically connected will heat up under the influence of the electricity supply. For example, six copper wires encased in low density polyethylene (LDPE) forming a tape can be heat bonded to the abraded surface on the web. These wires can be approximately 0.5 mm in diameter. However, thicker wires can be used to reduce the electrical resistance therein and these wires can for example be places approximately 2 mm apart and encased in the LDPE. The tape 18 is much narrower than the web 10, and is sealed to the abraded region 16 by a heat sealing device 20. The travel of the web or strip 18 as applied to the web is illustrated by arrow 22. This process is repeated along the opposing face of the web 10 and at approximately the centre of the web using the same components 14′, 18′, 20′ to abrade and attach a length of wires thereto.

Thus, the abraded surfaces of the web that come into contact with the wires when the web is folded are wider than is necessary to allow for variation in host pipe diameter when a pipe is being lined and this abrasion should ideally be completed prior to tube formation so as to remove any surface oxidation.

The web 10 as treated then passes through rollers 24 and 26, which are guide rollers, and is then wound on to roll 30 for subsequent use and transport to site.

On site, the roll is formed into a channelled member, such as a tube and is passed into a host pipe so that it is approximately 60% of the diameter of the host pipe. This form can be maintained by taping the same down in the host pipe. FIG. 1b illustrates a former 31 through which the formed and treated web and an inflating membrane is passed into centre of the pipeline 39 to be lined as illustrated in FIGS. 1c and d with the web passing in the direction indicated by arrow 33 and the web typically between 25 and 60% of the pipeline size. The front end 35 of the web which is first introduced into the pipeline is sealed 37 and attached to a skid to stop the front surface of the web from being damaged. This portion is subsequently pulled out of the other end of the pipeline and removed.

The inflating membrane used is typically made of nylon and is heat resistant. The membrane is typically inflated using heated air, such as at 120 degrees C. at about 1 bar pressure to keep the lining material warm, soft and flexible to help the lining material to conform to the inside surface of the host pipe. Whilst the tube is being rolled and taped, a polyethylene based slip seal expanding piece can be fitted to the edge of the web to keep external overlap of the web clean whilst the pipe lining is being installed. This seal keeps the tube joint clean and free from foreign matter.

In order to protect the joints which are formed in the roll tape can be applied over the same such that as the web expands within the pipeline the tape simply becomes waste but has acted to protect the joints during the introduction of the same into the pipeline.

The skid or sledge that is attached to the ends of the newly folded pipe lining is typically disposed after formation and typically covers less than 180 degrees arc of the tube lining.

The materials which are used can be selected to suit particular requirements but in one example, the web is formed of high density polyethylene and the tape used to support the wires when attached to the web is made from low density polyethylene to allow the tape to melt under the heat from the heating means 20, and attach the wire but not the web itself.

The lining pipe is fused by passing a current down the wires, continuously or sequentially depending on the length of the lining material. When the lining material adjacent the wires typically reaches approx. 140 degrees C., good fusion between the edges of the lining is achieved. The nylon inflatable membrane is then removed and fusion is checked using a CCTV camera. Good fusion is achieved and is obvious to see when the tape, which is normally a clear natural material has become discoloured, typically nearly black in colour.

FIG. 2 at sections A to D show the web 10 in section and how the edges of the web 10 are chamfered as indicated at 39 and 40 in order to enhance the overlap in the finished tube.

At Section B of FIG. 2, the abrading 16′ is shown as having been applied, whilst at section C the wire mesh strip 18′ is shown as having been applied. Finally at section D, the subsequent abrading 16 and adherence of wires 18 is shown as having been applied.

Moving now to FIG. 4, this shows the web 10 in the tubular coil form 34 with the respective edges overlapped. The degree of 12 overlap at this stage is related to the host pipe into which the tube is to be fitted, and may typically be in the order of 35%. The wire portions 18 and 18′ are shown as are sealing means 36. In practice, the tube is put into the host pipe in this form and then is expanded (details given hereinafter) until the coiled tube 34 lies tightly on the surface of the host pipe. In this process, the effect of the sealing means 36 is released, and subsequently by the application of electrical power to the wire strips 18, 18′, the final seal is formed between the overlapped edges, completing the installation. When the tube is pulled into the pipe, the joint should preferably be on the invert, that is to say on the bottom of the host pipe This is because connections are nearly always in the top half of the pipe, and one should avoid making new connections through the fused region of the tube.

To protect the overlapped joint against abrasion during installation, a half round sheet of throw away quality plastic can be placed over the joint, it being pulled in with the tube. This sheet is removed after installation, but prior to expansion of the tube.

The process described in relation to FIG. 1 is carried out completely under factory conditions, and when the tube is completed, it may be coiled for storage and subsequent transport.

The above gives a general outline of one embodiment of the invention and the following specific details related to that embodiment are not intended to be limiting.

The web 10 preferably is extruded in a size related to the diameter of the host pipe and may be typically of a thickness of the order of 2 to 6 mm. The length of pipe to be lined can be considerable for example in the order of 200 m. The chamfering as at 39 and 40 reduces the internal step in the lining as illustrated in FIG. 3.

The abrasion step is to assist in the bonding by heat sealing.

The mesh strip 18 may have small 2 mm holes therein and it is calendared onto the abraded surface 16 by the applicator 20. The strip may typically be 60 mm wide.

When the tube in the condition shown in FIG. 4 is installed into the host pipe, in the first stage of installation the tube is internally pressurised using air of at least one bar pressure. Upon initial application of electric supply connected to the wire strips 18, 18′ the sealing means 36 heats and melts and as a result the overlapping edges slip one relative to another enabling the tube to increase in size until it is tight against the host pipe surface, at which stage the overlap of the edges is reduced to say 25%. With continued heating, subsequently, for example the wire strips heat up melting the plastic and causing a secure bond between the overlapped edges. The electric current which is applied is dependent upon the length of the wire strips and/or the number of wires. One possible value could be 15 Amps.

In one embodiment the wire strips 18, 18′ are connected such that the current passes along one wire strip and back along the other. Alternatively the current passes separately along each of the strips 18, 18′ and is carried back via a ground line. As a yet further alternative sequential heating of the wires can be performed ass will be described later.

The effective bonding can be monitored in that when the lining layers have fused the same change colour, hence allowing a visual indication to be detected by a visual monitoring means such as a camera unit which passes along the pipeline. Alternatively the temperature of the seals at both ends of the wire strips, and points intermediate can be detected and as a result of those readings, it can be determined whether the fusing will have taken place. A yet further alternative is to apply air pressure between adjacent joints formed by the wire strips 18, 18′ and if there is a pressure drop indicated then this will show a leakage in the joint formed.

The process is progressive insofar as the slipping and bonding take place progressively as the effect of the electricity supply passes along the wires strips. When bonding temperature is reached, the web material turns black along the lines of the strips 18, 18′.

The width of the heating strip may be in the order of 60 mm, and the thickness of the strip and the thickness of the strip 18 may be in the order of 1 mm.

When a smaller tube is being made, under factory conditions, it may be warmed and vacated on the inside so that it collapses into an ovoid shape. In this shape it is put onto a drum under tension, for storage purposes. Alternatively, the tube for storage purposes may be formed into a U configuration, and then taped so that it will remain in the U condition until it is to be used.

When it is to be used, it is pulled into the host pipe and then if it is of ovoid shape it may be reshaped into a round section by passing the tube through a set of warmed rollers as it is pulled into the host pipe. When it is in U shape, it is pulled into the host pipe in this condition, and the tapes are subsequently broken by pressurising the interior of the tube using air or by pulling a pig through the tube.

If the processed web is to be formed into the tube on site, then it is simply a matter of carrying out the stage of FIGS. 1b and c by passing the same through a former at the location of the site.

The sealing means 36 forms a barrier to the ingress of moisture or foreign matter which could impair the subsequent sealing of the overlapped edges.

FIGS. 5, 6 and 7 show a modified arrangement wherein the sealing strip 36 is replaced by a sealing web of black plastics material. Conveniently, referring to FIG. 5, the pipe 34 is shown in perspective view, and the black strip 18 is also illustrated as lying between the overlapped edges. Again, the overlap at this stage may be of the order of 60%. The black sealing web is indicated by reference numeral 42, and it is wrapped round the outer of the overlapped edges as shown clearly in FIGS. 6 and 7. Along one of its edges it is anchored at location 44 to the innermost of the overlapped edges of the tube 34, whilst its other edge is anchored at 46 along its length to the outer surface of the outer of the two overlapped edges of the tube 34. These anchorages 44 and 46 are seals, and so therefore the web 42 forms a sealing means preventing any ingress of moisture or foreign matter such as could impair the subsequent bonding effect created by the wire strips 18, 18′.

As with the previous embodiment, where tube 34 is of a relatively small size, the fabrication indicated in FIG. 5 will be completed under factory conditions, but if the tube 34 is of large size such that final assembly has to be performed on site, then web 42 is only bonded at anchorage 44 in the factory and then the web is coiled and the bond 46 made on site. To keep the tube 34 at the reduced size compared to the host pipe holding tapes may need to be applied across the web 42 and across the overlapped edges.

When the tube in the reduced size arrangement of FIG. 6 is introduced into the host pipe, it is subsequently inflated as above described until the position shown in FIG. 7 is reached, wherein the anchorage point 44 has moved clear of the extremity of the overlapping outer edge of the tube 34. The web 42 therefore has unfolded, and indeed it forms a support for the overlapping edges which is particularly useful in regions of the host pipe, for example at host pipe joints, where there are spaces in the host pipe surface.

Typically the wire strips 18, 18′ comprise interlinked electric resistance wires between the overlapped edges, and by passing electric current through these wires when the tube is placed in final position in the host pipe.

In FIG. 8 there is described a further embodiment of the invention wherein the web 10 is again abraded via means 14 and the wire strip 18 is applied. In the FIG. 8 arrangement, a series of bobbins 50 carry the electrical heating wires 52, and these wires 52 are pressed by roller 56 onto the abraded region 16 of the web 10 on a tape. Typically there may be 10 to 14 of the wires 52 arranged in parallel and side by side, but electrically isolated.

As the web 10 is advanced in a direction of arrow 12, the wires 52 pass under a deforming roller 58 which has deforming ribs 60 lying at right angles to the direction of the wires. The roller 58 is heated and is pressed against the web 10 so that the ribs 60 cause the wires to be firmly held on the web 10.

There results therefore a strip region 62 carrying the wires 52, the strip region 62 being adjacent the edge of the web as shown. A second set of wires can preferably be applied to the other edge of the web or intermediate the edges, but on the opposite side.

The abrading device 30 shown in FIG. 1 is adjustable transversely of the web to ensure that the abrasion region 32 will be in the correct position for overlapping the wire region 62.

One further form of installation apparatus is shown in side elevation and in plan in FIGS. 9 and 10, and it will be seen that roller 60 is one of a pair of pinch rollers 60, 64 to provide the kinking referred to above. Also shown in FIG. 9 by reference numeral 66 is a cutting shoe for each wire 52. The shoe 66 cuts a groove ahead of the application roller 66 ready to receive the respective wire, and FIG. 10 shows the lines of kinking 68 which are formed by the roller 58.

FIGS. 11, 12 and 13 show in more detail and to an enlarged scale one embodiment of how the wires 52 are applied to the sheet 10 to be firmly anchored therein.

FIG. 11 shows that the groove 70 for receiving each wire is in the form of a dovetail so that the wire 52 will be retained therein, whilst FIG. 12 shows that each rib 60 on the roller 58 forms a transverse groove 72 in the sheet 10, and at the same time causes the kink 74 in the wire 52 to push the wire 52 deeper into the sheet material 10. As the roller 58 is heated, there will be a certain degree of softening and melting of the sheet 10 so that the kink portion 74 in fact becomes embedded deeper in the sheet 10.

FIG. 13 shows a clear indication of the kink 74 and how it is located deeper in the sheet 10 than the remainder of the wire 52. These kinks may be at any suitable spaced interval in order to ensure the locking of the wires to the sheet 10.

It might be noted that in the example illustrated that the abrading device 30 is adapted to be moved transversely of the web by means of a screw feeding device 76 of known configuration.

When the thus formed web is coiled into the tube, as shown in FIG. 14, either in the factory when small tubes are being produced, or on site when larger tubes are being used, it is held in the coiled position by means of a retaining strip 78 anchored by one of its edges at anchorage 80 to the outer surface of the outer overlapped edge of the tube 34, and by its other edge at anchorage 82 at a location which is clear of the overlapping. In fact anchorages 80 and 82 are clear of the overlap. The web 78 is of a material which will stretch when put under pressure. The web 78 forms a sealing means preventing ingress of moisture and foreign matter, and it releases by stretching when the tube is put into the host pipe and then expanded for example by internal pressurisation to the size shown in FIG. 15 in which the tube lies tightly against the host pipe surface. The pressurisation may be by blowing up the tube using a blower which blows hot air at 120° C. The blower is arranged to blow in air and bleed it off for some time so that the material becomes soft and therefore takes up the shape of the pipe. At this stage, the wires 52 are charged with electrical current as herein described, to such an extent as to heat the adjacent overlaps of the web 10, and cause them to bond together.

In one embodiment the wires are powered sequentially, and to do this a commutating arrangement as illustrated in FIG. 16. In this arrangement, at one end the wires 52 are connected to a common terminal 84, whilst at the other end the wires 52 have individual terminals 86, and a commutating terminal 88 is sequentially moved into contact with the respective terminals 86 so that at any one time only one or perhaps two or three, but not all, of the wires 52 carries electrical power. In this way the power consumption is reduced although obviously the time taken to heat all the wires 52 to the required degree will be greater.

The web 78 typically might be a strip of black low density polyethylene of say 1 mm thick. If the tube is fabricated in the factory, both anchorages 82 and 80 are carried out in the factory, but if the tube is to be formed on site, only anchorage 82 is created in the factory, and the anchorage 80 is effected on site.

The positions of the anchorages 80 and 82 may be important if the strip 78 is to perform an additional supporting function at gaps in the host pipe surface as mentioned hereinbefore.

The heating effect carried out by the wires will depend upon the size and thickness of the tube and the voltage and current will be controlled appropriately but typically the wires may be heated up to the order of 200° C. The speed of sequential heating of the wires will also be significant.

The wires may typically be of 0.45 mm diameter and may be clean copper or of tin coated copper, and the wire thickness can be increased to reduce the resistance over long distances. The spacing between wires may be selected to be in proportion to the thickness of the sheet. As an example, the wires may be of 0.45 mm in diameter and spaced by no more than 2 mm, for a pipe of diameter 152 mm. Again the thickness of the wire will depend upon the thickness of the sheet and perhaps other variable parameters.

For the two strips of wires 18, 18′ it is not necessary that the same number of wires be used in each strip, and the abraded regions also may have to be of different widths to accommodate differential expansion of the tube as related to the fact that the host pipe may be of variable diameter.

Where the host pipe is not straight, the lining tube may be made to configure to the shape of the host pipe by softening the entire tube for example using infrared.

FIG. 18 shows another and preferred arrangement for the provision of the wires on the sheet to form the lining tube. In FIG. 18A, the wires of each set are typically 0.45 mm diameter copper wires, and they are coated as at 100, with black HDPE, the coating 100 having been applied whilst the wires are hot to improve the adhesion between wires and coating 100. The thus coated wires are adhered to a low density polyethylene (LDPE) tape 102, the wires being in this example, 2 mm apart. The adhesion is achieved in that the tape 102 has an adhesive surface 104 of pressure sensitive adhesive. The wires and the adhesive surface 104 is then covered with a release web, such as silicone coated paper 106, until the resulting assembly has the composite tape form shown in FIG. 18B. This wire strip is then reeled for storage until it is required to be used.

FIG. 17 shows how the wire strip of FIG. 18B is applied to the sheet edge for the purposes herein explained. The reeled composite wire strip 18 is unwound from a mandrel 110, and as it is unwound, the paper layer 106 is removed at roller 112, exposing wires 50, and the adhesive side of tape 102. The HDPE 10 sheet to which the wires are to be fixed is fed as shown at 114 until it meets the adhesive side of the wire strip 18 at heated pressure roller 116, and the sheet 10 and wire strip 18 are pressed and adhered together. The laminated tape 102, wires 50 and sheet 10 are then passed between the rollers 60, 64 for the purpose described in relation to FIG. 9. Using coated wires, 50 and carrying them on a release paper covered tape provides that the wires are kept particularly clean to prevent contamination, which could affect the adhesion and subsequent sealing.

In another arrangement, the wires are pre-encased in Low Density Polyethylene (LPDE) tape, in which case the tape is simply laminated to the sheet. Before being applied a hot air gun can be used to soften the LPDE tape to enhance laminating the series of wires to the sheet.

When the sheet 10, with the wires applied as above is installed in the host pipe, the sealing of the overlapped edges can be effected by powering the wires. When the wires are powered, the LDPE web 102 first of all melts, and in turn the HDPE sheet melts along with the coating 100 and the overlapped edges effectively fuse together forming a strong seal. If required further heating means such as an infrared source can be pulled along the inside of the lining tube to remove these imperfections. Also, using a black coating on the wires provides a means whereby infrared heating can be used as an alternative to the powering of the wires. Infrared only reacts with black materials, and as the sheet 10 usually will be transparent to infrared, it is important that the coating 100 and wire strip 18 are black. Wire strip 18 can be a solid web or a mesh. FIG. 18C shows the overlapped sealed edges in the final lining tube.

The method of the present invention can be used on any size pipe, such as from 3 inches to 2 metre diameter pipes. The web lining of up to 500 m can be aligned in the host pipe at any time and, by heating the wiring sequentially in one example, a minimum level of voltage is used whilst maximising the fusion of the edges of the lining material.

It is envisaged that although several aspects and embodiments are described, any of the features of any aspect or embodiment where appropriate can be used in any other aspect or embodiment.

1. A tube made by introducing an elongated web of heat sealable plastics material through a former and into a host pipe with the longitudinal edges of the web overlapping by a first predetermined amount, the host pipe of diameter larger than that of the tube, said tube expanded up to the diameter of the host pipe until the overlapping edges overlap by a second predetermined amount less than the first predetermined amount, after which the overlapped edges are heat sealed together, wherein the heat sealing is effected by the introduction of electric current along at least one wire strip positioned between the overlapping edges, said wire strip heating to a sufficient extent to form a bond between the material of the overlapping edges.

2. A tube according to claim 1 wherein the tube includes a sealing means arranged in relation to the overlapped edges to prevent ingress of foreign matter between the edges and into the tube interior, said sealing means being adapted to be released, deformed, expanded, contracted, folded or unfolded so as to allow the tube, after being placed in the host pipe of diameter larger than that of the tube, to be expanded up to the diameter of the host pipe.

3. A tube according to claim 2 wherein the sealing means is applied under factory conditions so that the completed tube can be taken to site and there will be no possibility of foreign matter reaching the surfaces to be heat sealed together.

4. A tube according to claim 2 wherein the sealing means can be applied or completed on the tube at the site location where the same is to be inserted into the host pipe.

5. A tube according to claim 1 wherein each of the overlapping edges has a wire strip applied thereto, said wire strip positioned on the respective faces of the edges so as to lie side by side when the tube is expanded to the size of the host pipe.

6. A tube according to claim 1 wherein the said wire strip runs along the length of the overlapping edges of the tube.

7. A tube according to claim 1 wherein the said wire strip is applied to the web of material via a plastic material to which the wires are bonded.

8. A method of lining a host pipe, comprising the steps of introducing an elongated web of plastics material into the host pipe such that longitudinal edges of the web overlap by a first predetermined amount, said host pipe having a diameter larger than that of the tube and the tube is expanded up to the diameter of the host pipe until the overlapping edges overlap by a second predetermined amount less than the first predetermined amount, after which the overlapped edges are sealed together via the heating of wires by providing a current along the same, said wires provided as part of one or more wire strips positioned on the web of plastics material to lie in the overlapping edges of the said web to form a seal between said web material.

9. A method according to claim 8 wherein the tube includes a sealing means arranged in relation to the overlapped edges to prevent ingress of foreign matter between the edges and into the tube interior during the insertion of the tube in the host pipe, said sealing means being released, deformed, expanded, contracted, folded or unfolded so as to allow the tube to be expanded up to the diameter of the host pipe, and then the overlapping edges sealed together.

10. A method according to claim 8 wherein wire strips are provided on both of the overlapping edges.

11. A method according to claim 10 wherein the wires in the wire strips are caused to carry an electric current when the tube is in position.

12. A method according to claim 11 wherein the wires during sealing, are powered sequentially, to limit instantaneous power demand.

13. A method according to claim 8 wherein the wire strip comprise a series of wires supported by a tape of plastics material said tape and hence wires joined to the web by heating the tape so as to bond the tape to the web.

14. A method according to claim 13 wherein the surface of the web of material is abraded prior to the bonding of the wire strips thereto.

15. (canceled)

16. (canceled)

17. A method according to claim 13 wherein the steps are performed in factory conditions and the web subsequently coiled for transport to site.

18. A method according to claim 14 wherein the steps are performed in factory conditions and the web subsequently coiled for transport to site.

19. A method according to claim 8 wherein the tube is introduced into the host pipe via a former which forms the web material into a tubular form.

20. A method according to claim 9 wherein the tube is introduced into the host pipe via a former which forms the web material into a tubular form.

21. A method according to claim 10 wherein the tube is introduced into the host pipe via a former which forms the web material into a tubular form.

22. A method according to claim 11 wherein the tube is introduced into the host pipe via a former which forms the web material into a tubular form.

23. A method according to claim 12 wherein the tube is introduced into the host pipe via a former which forms the web material into a tubular form.

24. A method according to claim 13 wherein the tube is introduced into the host pipe via a former which forms the web material into a tubular form.

25. A method according to claim 14 wherein the tube is introduced into the host pipe via a former which forms the web material into a tubular form.

26. A method according to claim 17 wherein the tube is introduced into the host pipe via a former which forms the web material into a tubular form.

27. A method according to claim 18 wherein the tube is introduced into the host pipe via a former which forms the web material into a tubular form.
